(19) United States
(12) Patent Application Publication
(10) Pub. No.: US 2007/0291693 A1
(43) Pub. Date: Dec. 20, 2007

(54) SELECTIVE CONTROL OF AUDIO QUALITY ON A MOBILE STATION

(75) Inventors: Charles P. Schultz, North Miami Beach, FL (US); Von A. Mock, Boynton Beach, FL (US); Douglas F. Thurber, Boca Raton, FL (US)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/424,157

(22) Filed: Jun. 14, 2006

(51) Int. Cl. H04Q 7/00

(52) U.S. Cl. 370/331

(57) ABSTRACT

A method (500) for selectively improving output multimedia quality on a mobile station (105). The method can include detecting a circumstance in which a user of the mobile station would benefit from receiving high quality multimedia information (120) as opposed to multimedia information presented in a standard manner. Responsive to the detected circumstance, at least one parameter of a communication signal which communicates the multimedia information to the mobile station can be configured to provide the multimedia information at a quality that is higher than a standard quality at which multimedia information otherwise would be provided. Circumstances that can be detected include whether the mobile station is activated in an environment having high background noise, whether the mobile station is activated in a vehicle, and/or whether the mobile station is moving at a rate of speed that is at least equal to a threshold value.

### BACKGROUND OF THE INVENTION

1. Field of the Invention

The present invention generally relates to mobile communications.

2. Background of the Invention

Mobile communication devices, such as mobile telephones and personal digital assistants (PDAs), are becoming ubiquitous throughout much of the world. Indeed, many people consider such devices an essential part of modern living. The quality of audio signals generated by mobile communications devices is sometimes less than desirable, however, especially when there is much background noise. For example, when a mobile telephone is being used in a moving vehicle or at a sporting event, it oftentimes is difficult to hear another party who is speaking. In such circumstances, merely increasing a mobile station's output volume is not always sufficiently effective for improving a listener's ability to recognize speech being communicated by the other party.

### SUMMARY OF THE INVENTION

The present invention relates to a method for selectively improving output multimedia quality on a mobile station. The method can include detecting a circumstance in which a user of the mobile station would benefit from receiving high quality multimedia information as opposed to multimedia information presented in a standard manner. Responsive to the detected circumstance, at least one parameter of a communication signal which communicates the multimedia information to the mobile station can be configured to provide the multimedia information at a quality that is higher than a standard quality at which multimedia information otherwise would be provided.

Detecting the circumstance in which the user of the mobile station would benefit from receiving high quality multimedia information can include receiving a quality indicator from the mobile station. Circumstances that can be detected include whether the mobile station is activated in an environment having high background noise, whether the mobile station is activated in a vehicle, and/or whether the mobile station is moving at a rate of speed that is at least equal to a threshold value. In one arrangement, automatically configuring at least one parameter of the communication signal can include configuring a sampling rate, a number of bits representing an audio sample, an encoding scheme, an encryption scheme and/or an equalization setting. In addition, bandwidth used to communicate the multimedia information to the mobile station can be increased. Further, a communications network over which to transmit the communication signal can be selected from a plurality of available communications networks. Also, at least one audio input transducer can be selected from a plurality of available audio input transducers to receive the multimedia information.

In response to automatically configuring the parameter, charges can be applied to an account associated with the mobile station. In another arrangement, it can be determined whether an account associated with the mobile station subscribes to a high quality multimedia service. If so, additional charges can be applied to the account.

The present invention also relates to a method for selectively improving output multimedia quality on a mobile station that includes detecting a circumstance in which a user of the mobile station would benefit from receiving high quality multimedia information as opposed to multimedia information presented in a standard manner. Responsive to the detected circumstance, an automatic request can be generated requesting that at least one parameter of a communication signal which communicates the multimedia information to the mobile station be configured to provide the multimedia information at a quality that is higher than a standard quality at which multimedia information otherwise would be provided. Detecting the circumstance can include detecting background noise, detecting a communications link with a vehicle, detecting an accelerometer signal and/or detecting a global positioning satellite (GPS) signal.

Equalization settings for encoding the multimedia information can be transmitted to a communication device generating the multimedia information. Further, a communications network over which to receive the multimedia information can be selected from a plurality of available communications networks. The multimedia information can be communicated to a multimedia presentation system. Also, a noise cancellation system for an environment in which the mobile station is located when a call session is established can be automatically activated.

The present invention also relates to an electronic apparatus that includes a detector that detects a circumstance in which a user of the electronic apparatus would benefit from receiving high quality multimedia information as opposed to multimedia information presented in a standard manner. The detector can include an audio processor that detects background noise, a second communications adapter that detects a communications link with a vehicle, an accelerator that detects acceleration of the electronic apparatus and/or a global positioning satellite (GPS) receiver that tracks movement of the electronic apparatus. The electronic apparatus also can include a controller that, responsive to the detected circumstance, automatically generates a quality indicator. Further, the electronic apparatus can include a communications adapter that transmits the quality indicator to a communication device from which the electronic apparatus will receive multimedia information.

### BRIEF DESCRIPTION OF THE DRAWINGS

Preferred embodiments of the present invention will be described below in more detail, with reference to the accompanying drawings, in which:

FIG. 1 depicts a communications system that is useful for understanding the present invention;

FIG. 2 depicts a block diagram of a mobile station that is useful for understanding the present invention;

FIG. 3 depicts a block diagram of a communication device that is useful for understanding the present invention;

FIG. 4 is a flowchart depicting a method for sending a quality indicator that is useful for understanding the present invention;

FIG. 5 is a flowchart depicting a method of selecting multimedia settings that is useful for understanding the present invention; and

FIG. 6 is a flow diagram depicting an example of a method for selectively providing high quality multimedia information in a dispatch communications network.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a method for detecting circumstances in which a user of a mobile station would benefit from receiving high quality multimedia information as opposed to multimedia information transmitted in a standard manner and, responsive to the detected circumstances, automatically configuring at least one parameter of a communication signal which communicates the multimedia information to the mobile station. For example, multimedia information to be transmitted to the mobile station can be encoded with a higher bit rate or resolution in comparison to standard encoding parameters. The multimedia information also can be encoded with a low loss encoding scheme. Increasing the quality of multimedia information in this manner facilitates user processing of the information in comparison to processing of multimedia information presented in a standard manner. For instance, when a mobile station is being used in a moving vehicle or otherwise noisy environment, increasing the quality of audio information can reduce the amount of concentration required of the user to process such information.

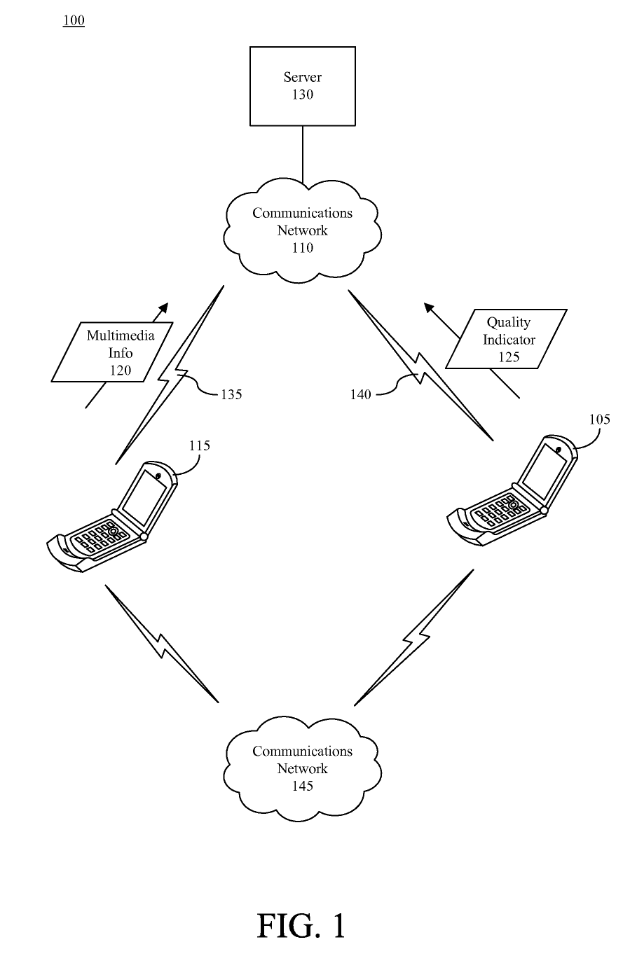

FIG. 1 depicts a communications system 100 that is useful for understanding the present invention. The communications system 100 can include an electronic apparatus, such as a mobile station 105. The mobile station 105 can be a mobile computer, a personal digital assistant (PDA), a mobile telephone, such as a cellular telephone or a push-to-talk (PTT) telephone, a game console, or any other mobile device that may be used to communicate via a communications network 110.

The communications network 110 can include the Internet, the World Wide Web, a wide area network (WAN), a local area network (LAN), a cellular communications network, a dispatch communications network, a public switched telephone network (PSTN), or any other communications network over which communications can be propagated. In that regard, the communications network 110 can include wired and/or wireless communication links.

The system 100 also can include a communication device 115. The communication device 115 can be a mobile station or a non-mobile communication device. For example, the communication device 115 can be a computer, a PDA, a telephone, a mobile telephone, such as a cellular telephone or a PTT telephone, a game console or any other device that may be used to communicate with the mobile station 105 via the communications network 110.

In operation, the mobile station 105 can detect conditions which indicate that it would be desirable to receive multimedia information 120 (e.g. audio/video, exclusively audio or exclusively video) from the communication device 115 at a quality that is higher than a standard quality level. For example, the mobile station 105 can detect that it is being used in a noisy environment by measuring an amount of background noise. The mobile station 105 also can detect whether it is being used in a vehicle. For example, the mobile station 105 can detect the presence of a vehicle Bluetooth adapter or Bluetooth beacon which is paired with the mobile station 105. In another aspect of the invention, the mobile station 105 can detect activation of a noise cancellation system within a vehicle.

The mobile station 105 also can detect whether it is being used in a vehicle, worn by a person who is performing a physical activity, for instance skiing, skateboarding, skydiving, etc., or by detecting movement at a rate of speed equal to or greater than a threshold value. For example, the mobile station 105 can utilize one or more global positioning satellite (GPS) services, or any other suitable positioning services, to detect such movement. In another arrangement, an accelerometer can be used to detect acceleration, which indicates movement. The mobile station 105 also can detect any other parameters indicative of the mobile station 105 being used within a vehicle.

In response to detecting a circumstance that indicates it would be desirable to receive the multimedia information 120 at a quality that is higher than a standard quality level, the mobile station 105 can communicate a quality indicator 125 to the communication device 115 and/or another node of the communications network 110, for instance network infrastructure, such as a server 130, a basestation, or a basestation controller. The quality indicator 125 can be a message, a flag that is set in a header or footer of data packet or frame, or any other indication suitable for indicating that high quality multimedia information is requested. Moreover, the configuration of the mobile station 105 can be optimized for the detected circumstance. For example, the mobile station 105 can be configured to optimize its presentation of high quality multimedia information.

In response to receiving the quality indicator 125, the communication device 115 can increase the quality of communication signals it communicates to the mobile station 105. For example, the communication device 115 can encode audio information with a sampling rate that is higher than a standard sampling rate used by the communication device 115, increase the number of bits representing each audio sample, change a vocoder encoding scheme to a scheme that is less lossy than a standard vocoder scheme, or implement any other processes suitable for improving quality of the multimedia information 120. In another arrangement, the mobile station 105 also can send equalization settings to be used by the communication device's vocoder when encoding the multimedia information 120. The equalization settings can be settings which are optimized for the user of the mobile station 105, for instance based on user preferences.

Changing the encoding scheme used to encode the multimedia information 120 can increase the amount of data communicated between the communication device 115 and the mobile station 105. To accommodate the increase, the bandwidth allocated for an uplink 135 from the communication device 115 and for a downlink 140 to the mobile station 105 can be increased. For example, the amount of bandwidth can be doubled. Allocation of the bandwidth can be controlled by the network infrastructure, for instance a server 130, a basestation, a basestation controller, or by any other suitable component of the communications network 110.

In another arrangement, communication signals can be buffered or otherwise altered by the server 130 prior to being transmitted to the mobile station 105 or the communication device 115. For example, the server 130 may process the communications signals by applying translation, text-to-speech services, or other processes that may affect the quality of such signals. In such an arrangement, the amount of storage space allocated by the server can be increased and/or higher quality processing schemes can be applied to the communication signals to increase the quality of such signals.

In yet another arrangement, certain features of the mobile station 105 can be disabled to accommodate the increased amount of data, prioritize tasks for presentation of high quality multimedia information 120, preserve battery life while presenting the high quality multimedia information 120, or accomplish any other suitable task. For instance, mobile station features that are not likely to be useful to a user while driving can be disabled. Examples of such features include, but are not limited to, web browsing and instant messaging.

In one arrangement, if a plurality of input transducers (e.g. microphones) are available for detecting acoustic signals communicated by a user of the communication device 115, an input transducer that receives the acoustic signals with the highest quality can be selected to receive the acoustic signals. Similarly, if there are a plurality of output transducers (e.g. loudspeakers) available to the mobile station 105 for generating acoustic signals from the multimedia information 120, one or more of the output transducers that generate acoustic signals with the highest quality can be selected to generate the acoustic signals. For example, the mobile station 105 can connect to another multimedia presentation system, such as an audio system within a vehicle, via a Bluetooth communication link and communicate audio signals contained in the multimedia information 120 to the audio system. Further, if the vehicle includes a noise cancellation system, the mobile station 105 can selectively activate the noise cancellation system to cancel background noise during call sessions.

In yet another arrangement, if the mobile station 105 and/or the communication device 115 are simultaneously connected to a plurality of communications networks 110, 145, the communications network 145 that communicates the multimedia information 120 with the highest level of quality can be selected to propagate the multimedia information 120 from the communication device 115 to the mobile station 105. In addition, the data compression/encryption that is used to compress and/or encrypt the multimedia information 120 for communication over the communications network 145 can be selected to provide a high level of quality. Still, a myriad of other settings can be changed on the mobile station 105, the communication device 115, the communications network 110, and/or the communications network 145 in response to the quality indicator 125. Accordingly, the invention is not limited in this regard.

A service for providing high quality multimedia information to the mobile station 105 can be provided for a monthly charge. For instance, it can be determined whether an account associated with the mobile station 105 subscribes to the high quality multimedia service. If so, monthly charges can be applied to the account. In another arrangement, the high quality multimedia service can be provided on an as needed basis, in which case charges can be applied when the high quality multimedia service is used. For example, in response to automatically configuring a parameter to provide the multimedia information 120 at a quality that is higher than a standard quality, charges can be applied to an account associated with the mobile station 105. In yet another arrangement, charges can be applied to prepaid call units that are managed by the mobile station 105 when high quality multimedia services are used.

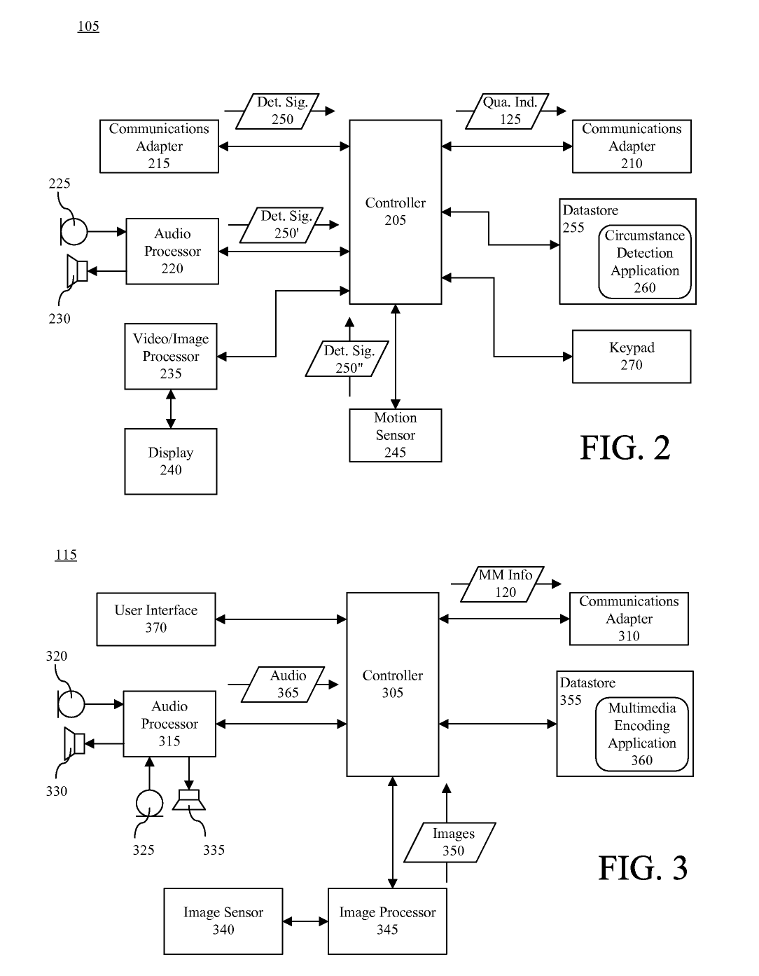

FIG. 2 depicts a block diagram of an example of the mobile station 105 that is useful for understanding the present invention. The mobile station 105 can include a controller 205. The controller 205 can comprise, for example, a central processing unit (CPU), a digital signal processor (DSP), an application specific integrated circuit (ASIC), a programmable logic device (PLD), a plurality of discrete components that cooperate to process data, and/or any other suitable processing device.

The mobile station 105 also can include a communications adapter 210 that is used by the mobile station 105 to communicate with the communications network. The communications adapter 210 can include, for example, a transceiver that communicates data via IEEE 802 wireless communications, WPA, WPA2, GSM, TDMA, CDMA, WCDMA, direct wireless communication, TCP/IP, or any other suitable form of mobile communications.

A second communications adapter 215 also can be provided support communications between the communication device 120 and other devices, for example vehicle accessories. The second communications adapter 215 also can be used to detect when the mobile station 105 is proximate to such devices. For example, the communications adapter 215 can include a transceiver that communicates short range signals in accordance Bluetooth and/or detects Bluetooth beacons. In one arrangement, the second communications adapter 215 can be integrated with the communications adapter 210.

The mobile station 105 also can include an audio processor 220 connected to an input audio transducer 225 (e.g. microphone) and an output audio transducer 230 (e.g. loudspeaker). The audio processor 220 can comprise a vocoder for encoding and decoding speech signals. Vocoders are known to the skilled artisan. The audio processor 220 can be integrated with the controller 205, or provided as a separate component that is communicatively linked to the controller 205. The audio processor 220 can comprise a CPU, a DSP, an ASIC, a PLD, a plurality of discrete components that cooperate to process audio data, and/or any other suitable audio processing device.

The audio processor 220 can receive input audio signals from a user via the input audio transducer 225, and propagate output audio signals to the user via the output audio transducer 230. In one arrangement, the audio processor also can propagate output audio signals to the user via the second communications adapter 215. For example, the audio processor 220 can forwarded decoded audio signals to the communications adapter 215, which can communicate the audio signals to an audio system within a vehicle that is suitably configured to receive such communications.

The mobile station 105 also can include a video processor 235 connected to a display 240. The video/image processor 235 can be integrated with the controller 205, or provided as a separate component that is communicatively linked to the controller 205. The video processor 235 can comprise a CPU, a DSP, an ASIC, a PLD, a plurality of discrete components that cooperate to process video data, and/or any other suitable audio processing device. The video processor 235 can display images to the user via the display 240.

A motion sensor 245 can be communicatively linked to the controller 205. The motion sensor 245 can be, for example, a GPS receiver or an accelerometer. A GPS receiver can receive GPS signals from one or more GPS systems to track location and movement of the mobile station 105. An accelerometer can detect acceleration of the mobile station 105, which indicates movement. The motion sensor 245 can communicate data corresponding to the mobile station's location and movement to the controller 205.

The mobile station 105 also can include a datastore 255. The datastore 255 can include a magnetic storage medium, an electronic storage medium, an optical storage medium, a magneto-optical storage medium, or any other storage medium suitable for storing digital information. In one arrangement, the datastore 255 can be integrated into the controller 205.

A circumstance detection application 260 can be contained on the datastore 255 to execute processes described herein. In particular, the circumstance detection application 260 can be executed by the controller 205 to detect whether a user of a mobile station 105 would benefit from receiving high quality communication signals over the communications adapter 210 as opposed to communication signals transmitted in a standard manner. For example, the controller 205 can receive a detection signal 250 from the communications adapter 215 which indicates whether the mobile station 105 is communicatively linked to a vehicle via the communications adapter 215. In one aspect of the invention, the detection signal 250 can include a vehicle identifier.

In another arrangement, the controller 205 can receive a detection signal 250′ from the audio processor 220 which indicates whether the mobile station 105 is communicatively linked to a vehicle via the communications adapter 215. For example, the audio processor 220 can monitor audio signals received from the input audio transducer 225 and process the audio signals to determine whether the signals indicate that the mobile station 105 is activated in a noisy environment. For instance, algorithms can be applied to process the data in a manner that identifies a level of background noise. In another arrangement, the audio processor 220 can compare a spectral content of received audio signals with the known spectral content of background noise.

In yet another aspect of the inventive arrangements, the controller 205 can receive a detection signal 250″ from the motion sensor 245. In an arrangement in which the motion sensor 245 is a GPS receiver, the detection signal 250″ can indicate the position of the mobile station 105 and the controller 205 can process a plurality of such signals at known intervals to determine whether the mobile station 105 is moving, and at what speed. In another arrangement, the motion sensor 245 can determine whether the mobile station 105 is moving and detect the speed, then forward such data to the controller 205 in the detection signal 250″. In an arrangement in which the motion sensor 245 is an accelerometer, the motion sensor 245 can detect an acceleration greater than a threshold value and forward a corresponding acceleration indicator in the detection signal 250″.

If it is determined that the user of the mobile station 105 would benefit from receiving high quality communication signals over the communications adapter 210, the controller 205 can communicate the quality indicator 125 via the communications adapter 210. The quality indicator 125 can be communicated to the communication device with which the mobile station 105 is establishing a call session, network infrastructure, and/or any other network node suitable for causing high quality multimedia signals to be sent to the mobile station 105.

In one arrangement, the circumstance detection application 260 can present a user selectable option via the display 240 which allows the user to selectively enable or disable implementation of high quality multimedia mode by entering an input into a keypad 270 or a button. For example, charges may be applied to an account associated with the mobile station 105 for use of additional bandwidth that may be required to receive the high quality multimedia information, and the user may not wish to pay such charges. Further, the circumstance detection application 260 can present an icon or other indicator on the display 240 when the mobile station 105 is requesting high quality multimedia information, or when such a call session is established, to alert the user that additional bandwidth may be used.

FIG. 3 depicts a block diagram of an example of the communication device 115 that is useful for understanding the present invention. The communication device 115 can include a controller 305. The controller 305 can comprise, for example, a CPU, a DSP, an ASIC, a PLD, a plurality of discrete components that cooperate to process data, and/or any other suitable processing device.

The communication device 115 also can include a communications adapter 310 that is used by the communication device 115 to communicate with the communications network. The communications adapter 310 can include, for example, a transceiver that communicates data via IEEE 802 wireless communications, WPA, WPA2, GSM, TDMA, CDMA, WCDMA, direct wireless communication, TCP/IP, or any other suitable form of mobile communications.

The communication device 115 also can include an audio processor 315 connected to one or more input audio transducers 320, 325 and one or more output audio transducers 330, 335. The audio processor 315 can comprise a vocoder for encoding and decoding speech signals. Vocoders are known to the skilled artisan. The audio processor 315 can be integrated with the controller 305, or provided as a separate component that is communicatively linked to the controller 305. The audio processor 315 can comprise a CPU, a DSP, an ASIC, a PLD, a plurality of discrete components that cooperate to process audio data, and/or any other suitable audio processing device.

In one arrangement, a second audio processor (not shown) can be provided and communicatively linked to the audio processor 315 and/or the controller 305. For example, the second audio processor can be integrated with a communication accessory, such as a headset, and wirelessly linked to the controller 305. In such an arrangement, the input audio transducer 325 and the output audio transducer 335 can be connected to the second audio processor.

The communication device 115 also can include an image sensor 340 that detects images. The image sensor 340 can include a charge-coupled device (CCD), a complementary metal oxide semiconductor (CMOS) image sensor, or any other image sensor suitable for capturing images. Such sensors are known to the skilled artisan. An image processor 345 can be operatively connected to the image sensor 340 and process the images detected by the image sensor 340 and generate image data 350 comprising still images or video information. Image processors also are known to those skilled in the art.

The communication device 115 also can include a datastore 355. The datastore 355 can include a magnetic storage medium, an electronic storage medium, an optical storage medium, a magneto-optical storage medium, or any other storage medium suitable for storing digital information. In one arrangement, the datastore 355 can be integrated into the controller 305.

A multimedia encoding application 360 can be contained on the datastore 355 and executed by the audio processor 315, the image processor 345 and/or the controller 305 to perform processes described herein. The multimedia encoding application 360 can be executed to select the input audio transducer 320 or the input audio transducer 325 from which to receive input audio signals. For example, the input audio transducer 320, 325 known to generate the highest quality audio signals can be selected for receiving audio signals in response to the quality indicator being communicated by the mobile station 105.

In addition, the multimedia encoding application 360 can be executed when encrypting audio signals received from the input audio transducer 320 and/or the input audio transducer 325, and/or encrypting image data 350 received from the image sensor 340. For example, the multimedia encoding application 360 can select a vocoder algorithm that is used by the audio processor 315 to compress audio signals 365 prior to the audio signals 365 being communicated to the controller 305. The multimedia encoding application 360 also can select an encryption algorithm that is used by the controller 305 to encrypt the audio signals 365, along with any other multimedia signals that may be communicated, such as the video signals 350, into the multimedia information 120. The controller 305 then can forward the multimedia information 120 to the communications adapter 310, which can communicate the multimedia information 120 to the mobile station.

In one arrangement, the multimedia encoding application 360 also can communicate with a user interface 370 on the communications device 115 and present a user of the communication device an option to accept or reject the request to provide high quality multimedia information. For example, charges may apply for use of additional bandwidth that may be required to transmit the high quality multimedia information 120, and the user may not wish to pay such charges. Further, the multimedia encoding application 360 can present an icon or other indicator on the user interface 370 when a call requesting high quality multimedia information is being requested, or when such a call session is established.

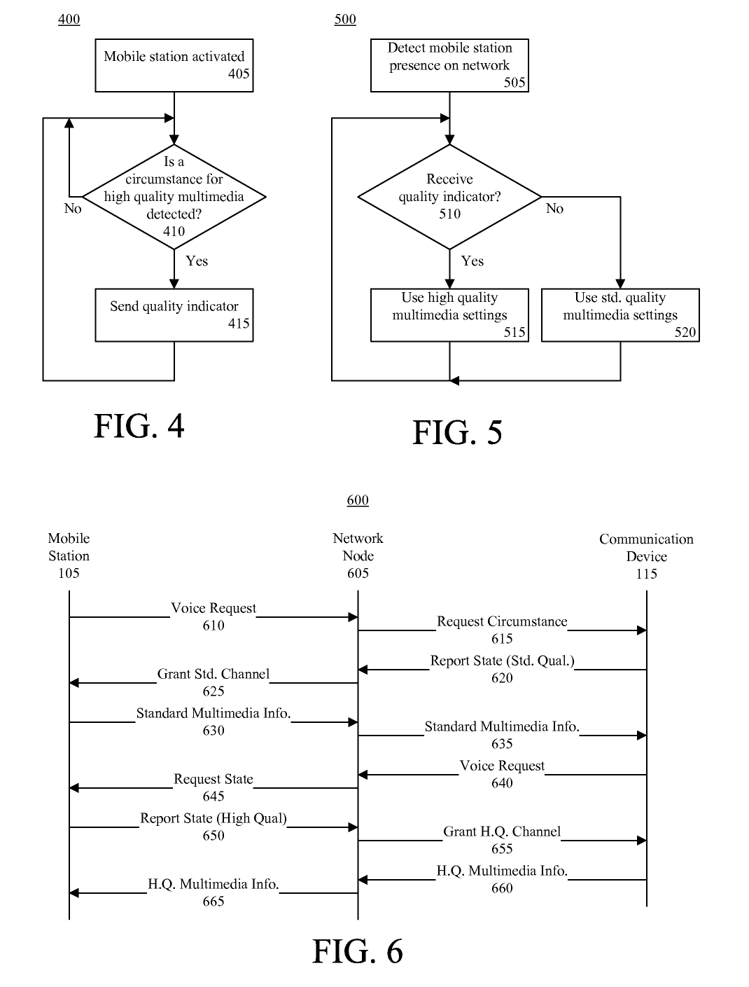

FIG. 4 is a flowchart depicting a method 400 for sending a quality indicator that is useful for understanding the present invention. At step 405 a mobile station can be activated. Referring to decision box 410, if on the mobile station a circumstance is detected which indicates that high quality multimedia information would be beneficial for a user of the mobile station, at step 415 a quality indicator can be transmitted via a communications network with which the mobile station is communicatively linked. For example, the quality indicator can be sent to a communication device with which the mobile station is establishing a call, or infrastructure of a communications network, such as a server, a basestation, a basestation controller, or any other suitable network node. In one arrangement, the quality indicator can be sent once to establish the settings for a call session. In another arrangement, the quality indicator can be sent at periodic interval. For example, the quality indicator can be a flag set in a header or footer of a data packet or frame. Accordingly, the communication device or the network infrastructure can respond to a change in circumstances associated with the mobile station.

FIG. 5 is a flowchart depicting a method 500 of selecting multimedia settings that is useful for understanding the present invention. At step 505 a mobile station's presence can be detected on the communications network. Referring to decision box 510, if a quality indicator is received from the mobile station, at step 515 high quality multimedia settings can be used. For example, if the quality indicator is received by a network infrastructure component, such as a server, basestation or basestation controller, high quality multimedia encoding and buffering can be implemented. Moreover, a greater amount of bandwidth can be allocated for downlink to the mobile station and uplink from another communication device communicating with the mobile station. In that regard, if the quality indicator is received on the communication device, the communication device can select a multimedia compression scheme and/or encoding scheme to provide high quality multimedia information. If, however, a quality indicator is not received, at step 520 standard multimedia settings can be used by the communication device and the network infrastructure for the call session.

Referring again to step 510, monitoring for a quality indicator can continue and the multimedia settings can be changed in response to the quality indicator being changed during a call session, the quality indicator no longer being received during a call session, or the quality indicator being received during a call session in which it was not previously received. For example, in response to a user of the mobile station entering his car while participating in a call session, the mobile station can transmit the quality indicator to the communication device and/or the network infrastructure. In response to the quality indicator, parameters for the communication signal communicating the multimedia information can be changed to convey the multimedia information at a high quality. Similarly, if the user exits his car while still participating in the call session, the communication device and/or the network infrastructure can detect that the quality indicator is no longer being received, or detect a change in the quality indicator, and thus change parameters for the communication signal to standard multimedia settings. Nonetheless, in one aspect of the invention use of high quality multimedia settings can be established by a user preference. In such an arrangement, the high quality multimedia settings can be maintained whether or not the user enters or leaves his vehicle.

FIG. 6 is a flow diagram depicting an example of a method 600 for selectively providing high quality multimedia information in a dispatch communications network. At step 610, the mobile station 105 can communicate to a node 605 of the dispatch communications network a voice request for the communication device 115. At step 615, the network node 605 can request the state of the communication device 115, for example, whether the communication device 115 is activated in a vehicle. In response, at step 620 the communication device 115 can report its state to the network node 605. For example, the communication device 615 can respond with a data packet in which the quality indicator flag is not set, in which case audio transmitted to the communication device 615 at standard quality is acceptable. At step 625 the network node 605 can grant a standard quality uplink channel to the mobile station 105. At step 630 the mobile station 105 can transmit standard quality multimedia information (e.g. audio information) to the network node 605, which at step 635 can transmit the standard multimedia information to the communication device 115.

Continuing to step 640, the communication device 115 can communicate to the network node 605 a voice request for the mobile station 105. At step 645, the network node 605 can request the state of the mobile station 105, for example, whether the mobile station 105 is activated in a vehicle. In response, at step 650 the mobile station 105 can report its state to the network node 605. For example, the mobile station 105 can respond with a data packet in which the quality indicator flag is set, thereby indicating that it is preferred for audio communicated to the mobile station 105 to be transmitted using high quality multimedia settings. At step 655, the network node 605 can grant a high quality uplink channel to the communication device 115. At step 660 the communication device 115 can transmit high quality multimedia information to the network node 605, which at step 665 can transmit the high quality multimedia information to the mobile station 105.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in an application product, which comprises all the features enabling the implementation of the methods described herein, and which when loaded in a processing system is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The term “multimedia information,” as used herein, is defined as audio information, video information, or a combination of audio information and video information. The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically, i.e. communicatively linked through a communication channel or pathway.

This invention can be embodied in other forms without departing from the spirit or essential attributes thereof. Accordingly, reference should be made to the following claims, rather than to the foregoing specification, as indicating the scope of the invention.

What is claimed is:

1. A method for selectively improving output multimedia quality on a mobile station, comprising:
detecting a circumstance in which a user of the mobile station would benefit from receiving high quality multimedia information as opposed to multimedia information presented in a standard manner; and
responsive to the detected circumstance, automatically configuring at least one parameter of a communication signal which communicates the multimedia information to the mobile station to provide the multimedia information at a quality that is higher than a standard quality at which multimedia information otherwise would be provided.

2. The method of claim 1, wherein detecting the circumstance in which the user of the mobile station would benefit from receiving high quality multimedia information comprises receiving a quality indicator from the mobile station.

3. The method of claim 1, wherein automatically configuring at least one parameter of the communication signal comprises configuring at least one parameter selected from the group consisting of a sampling rate, a number of bits representing an audio sample, an encoding scheme, an encryption scheme and an equalization setting.

4. The method of claim 1, further comprising automatically increasing a bandwidth used to communicate the multimedia information to the mobile station.

5. The method of claim 1, wherein automatically configuring at least one parameter of the communication signal comprises selecting a communications network over which to transmit the communication signal, the communications network selected from a plurality of available communications networks.

6. The method of claim 1, wherein detecting the circumstance in which the user of the mobile station would benefit from receiving high quality multimedia information comprises detecting that the mobile station is activated in an environment having high background noise.

7. The method of claim 1, wherein detecting the circumstance in which the user of the mobile station would benefit from receiving high quality multimedia information comprises detecting at least one circumstance selected from the group consisting of detecting that the mobile station is activated in a vehicle and detecting that the mobile station is moving at a rate of speed that is at least equal to a threshold value.

8. The method of claim 1, further comprising selecting at least one audio input transducer to receive the multimedia information from a plurality of available audio input transducers.

9. The method of claim 1, further comprising:
responsive to automatically configuring the at least one parameter, applying charges to an account associated with the mobile station.

10. The method of claim 1, further comprising:
determining whether an account associated with the mobile station subscribes to a high quality multimedia service; and
if the account does subscribe to the high quality multimedia service, applying additional charges to the account.

11. A method for selectively improving output multimedia quality on a mobile station, comprising:
detecting a circumstance in which a user of the mobile station would benefit from receiving high quality multimedia information as opposed to multimedia information presented in a standard manner; and
responsive to the detected circumstance, automatically requesting that at least one parameter of a communication signal which communicates the multimedia information to the mobile station be configured to provide the multimedia information at a quality that is higher than a standard quality at which multimedia information otherwise would be provided.

12. The method of claim 11, further comprising transmitting to a communication device generating the multimedia information equalization settings for encoding the multimedia information.

13. The method of claim 11, wherein detecting the circumstance comprises detecting background noise.

14. The method of claim 11, wherein detecting the circumstance comprises detecting a communications link with a vehicle.

15. The method of claim 11, wherein detecting the circumstance comprises detecting at least one signal selected from the group consisting of an accelerometer signal and a global positioning satellite (GPS) signal.

16. The method of claim 11, further comprising communicating the multimedia information to a multimedia presentation system.

17. The method of claim 11, further comprising selecting a communications network over which to receive the multimedia information, the communications network selected from a plurality of available communications networks.

18. The method of claim 11, further comprising automatically activating a noise cancellation system for an environment in which the mobile station is located when a call session is established.

19. An electronic apparatus, comprising:
a detector that detects a circumstance in which a user of the electronic apparatus would benefit from receiving high quality multimedia information as opposed to multimedia information presented in a standard manner; and
a controller that, responsive to the detected circumstance, automatically generates a quality indicator; and
a communications adapter that transmits the quality indicator to a communication device from which the electronic apparatus will receive multimedia information.

20. The electronic apparatus of claim 19, wherein the detector comprises at least one component selected from the group consisting of an audio processor that detects background noise, a second communications adapter that detects a communications link with a vehicle, an accelerator that detects acceleration of the electronic apparatus, and a global positioning satellite (GPS) receiver that tracks movement of the electronic apparatus.
